(19) United States
(12) Patent Application Publication
(10) Pub. No.: US 2022/0324109 A1
(43) Pub. Date: Oct. 13, 2022

(54) METHOD AND APPARATUS FOR CONTROLLING MULTI-LEGGED ROBOT, AND STORAGE MEDIUM

(71) Applicant: BEIJING BAIDU NETCOM SCIENCE TECHNOLOGY CO., LTD., Beijing (CN)

(72) Inventors: Hongsheng Zeng, Beijing (CN); Bo Zhou, Beijing (CN); Fan Wang, Beijing (CN); Yongfeng Chen, Beijing (CN); Jingzhou He, Beijing (CN)

(73) Assignee: BEIJING BAIDU NETCOM SCIENCE TECHNOLOGY CO., LTD., Beijing (CN)

(21) Appl. No.: 17/809,687

(22) Filed: Jun. 29, 2022

(30) Foreign Application Priority Data
Jun. 30, 2021 (CN) 202110736096.8

(51) Int. Cl. B25J 9/16; B62D 57/032

(52) U.S. Cl. CPC B25J 9/1664; B62D 57/032; B25J 9/1605

(57) ABSTRACT

Disclosed are a method and an apparatus for controlling a multi-legged robot, and a storage medium. The method includes: acquiring current state parameters of the multi-legged robot; when types and/or quantities of the current state parameters meet a first preset condition, acquiring a first motion control policy by inputting the current state parameters into a first model generated by training; and controlling the multi-legged robot based on the first motion control policy.

### CROSS REFERENCE TO RELATED APPLICATION

This application is based on and claims priority to Chinese Patent Application No. 202110736096.8, filed on Jun. 30, 2021, the entire content of which is hereby incorporated by reference.

### TECHNICAL FIELD

The disclosure relates to a field of computer technologies, and particularly to a field of artificial intelligence (AI) and deep learning (DL).

### BACKGROUND

With development of artificial intelligence (AI) technologies, more and more industries have made a breakthrough through effective combination with the AI technologies. Machine learning is a common research hotspot in the field of artificial intelligence and pattern recognition, and theory and method of which have been widely applied to solving complex problems in the field of engineering application and science.

A multi-legged robot has much better adaptation to environment than wheel type mobile robot and pedrail type mobile robots.

### SUMMARY

The disclosure provides a method and an apparatus for controlling a multi-legged robot, a storage medium.

According to a first aspect of the disclosure, a method for controlling a multi-legged robot is provided, and includes: acquiring current state parameters of the multi-legged robot; when types and/or quantities of the current state parameters meet a first preset condition, acquiring a first motion control policy by inputting the current state parameters into a first model generated by training; and controlling the multi-legged robot based on the first motion control policy.

According to a second aspect of the disclosure, an apparatus for controlling a multi-legged robot is provided, and includes: at least one processor; and a memory communicatively connected to the at least one processor. The memory is stored with instructions executed by the at least one processor, the at least one processor is configured to: acquire current state parameters of the multi-legged robot; when types and/or quantities of the current state parameters meet a first preset condition, acquire a first motion control policy by inputting the current state parameters into a first model generated by training; and control the multi-legged robot based on the first motion control policy.

According to a third aspect of the disclosure, a non-transitory computer readable storage medium stored with computer instructions is provided. The computer instructions are configured to execute a method for controlling a multi-legged robot by a computer. The method includes: acquiring current state parameters of the multi-legged robot; when types and/or quantities of the current state parameters meet a first preset condition, acquiring a first motion control policy by inputting the current state parameters into a first model generated by training; and controlling the multi-legged robot based on the first motion control policy.

It should be understood that the content described in the part is not intended to identify key or important features of embodiments of the disclosure, nor intended to limit the scope of the disclosure. Other features of the disclosure will be easy to understand through the following specification.

### BRIEF DESCRIPTION OF THE DRAWINGS

The drawings are intended to better understand the solution, and do not constitute a limitation to the disclosure.

FIG. 1 is a flowchart illustrating a method for controlling a multi-legged robot according to an embodiment of the disclosure;

FIG. 2 is a flowchart illustrating a method for controlling a multi-legged robot according to another embodiment of the disclosure;

FIG. 3 is a flowchart illustrating a method for controlling a multi-legged robot according to another embodiment of the disclosure;

FIG. 4 is a flowchart illustrating a method for controlling a multi-legged robot according to another embodiment of the disclosure;

FIG. 5 is a block diagram illustrating an apparatus for controlling a multi-legged robot according to an embodiment of the disclosure;

FIG. 6 is a block diagram illustrating an apparatus for controlling a multi-legged robot according to another embodiment of the disclosure;

FIG. 7 is a block diagram illustrating an apparatus for controlling a multi-legged robot according to another embodiment of the disclosure;

FIG. 8 is a block diagram illustrating an apparatus for controlling a multi-legged robot according to another embodiment of the disclosure;

FIG. 9 is a block diagram illustrating an electronic device configured to implement a method for controlling a multi-legged robot in embodiments of the disclosure.

### DETAILED DESCRIPTION

The example embodiments will be described in detail here, and examples thereof are shown in the accompanying drawings. When the following descriptions refer to the accompanying drawings, unless otherwise indicated, the same numbers in different drawings represent the same or similar elements. The implementations described in the following example embodiments do not represent all the implementations consistent with the present invention. Rather, they are merely examples of the apparatus and method consistent with some aspects of the present invention as detailed in the appended claims.

A multi-legged robot is a kind of bionic robot, has a motion trajectory formed by a series of discrete footprints, and contact ground based on discrete points during motion. The multi-legged robot has much better adaptation to environment than wheel type mobile robot and pedrail type mobile robots. Due to diversification and complexity of application scenarios of the multi-legged robot, improving reliability of motion control of the multi-legged robot has great significance.

A method and an apparatus for controlling multi-legged robot, an electronic device and a storage medium in the present disclosure are described below with reference to the accompanying drawings.

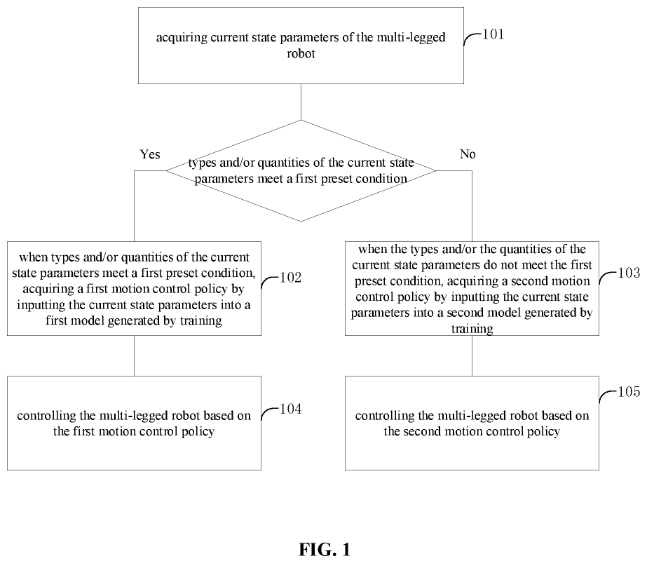

FIG. 1 is a flowchart illustrating a method for controlling a multi-legged robot according to an embodiment of the present disclosure. The method may be performed by an apparatus for controlling a multi-legged robot according to the present disclosure, and may also be performed by an electronic device according to the present disclosure. The electronic device may include, but not limited to, a terminal device such as a desktop computer and a tablet computer, and may also be a server. The following is an explanation of the disclosure by taking performing a method for controlling a multi-legged robot according to the disclosure through an apparatus for controlling a multi-legged robot according to the disclosure as an example.

As illustrated in FIG. 1, the method for controlling the multi-legged robot may include the following blocks.

At block 101, current state parameters of the multi-legged robot are acquired.

In an embodiment of the disclosure, the multi-legged robot may be any type of robot with a walking function, such as a quadruped robot, a hexapod robot, an eight-legged robot, which is not limited in the disclosure.

The state parameters (or posture parameters) of the multi-legged robot may be acquired by sensors arranged at different parts of the multi-legged robot. Therefore, the acquired state parameters of the robot are different due to different types of robots, and types and quantities of sensors arranged at different parts of the robot.

For example, for the quadruped robot, an overall structure of which may include a torso and four limbs of the robot. Each limb may include three degree-of-freedom (DOF) joints including two hip joints and one knee joint. Therefore, the four limbs of the quadruped robot totally have twelve DOF joints including eight hip joints and four knee joints.

Correspondingly, sensors arranged at different parts of the quadruped robot may include an inertial sensor (that is, an imu sensor) and a speed sensor arranged at a gravity center position of the torso of the quadruped robot, angular sensors and angular velocity sensors arranged at twelve joints of the quadruped robot, displacement sensors and pressure sensors arranged at four feet of the quadruped robot, etc.

Alternatively, for the hexapod robot, an overall structure of which may include a torso and six limbs of the robot. Each limb may include three DOF joints including two hip joints and one knee joint. Therefore, the limbs of the hexapod robot have eighteen DOF joints including twelve hip joints and six knee joints.

Correspondingly, sensors arranged at different parts of the hexapod robot may include an inertial sensor (that is, an imu sensor) and a speed sensor arranged at a gravity center position of a torso of the hexapod robot, angular sensors and angular velocity sensors arranged at eighteen joints of the quadruped robot, displacement sensors and pressure sensors arranged at six feet of the hexapod robot, etc.

Thus, the current state parameters of the multi-legged robot may include parameters such as a current angle of a joint, a current angular velocity of a joint, a speed of the torso, a position of a foot, a force stressed on a foot, data of the inertial sensor, etc.

It should be noted that the above examples are illustrative and may not be a limitation of the state parameters of the multi-legged robot in the embodiments of the disclosure.

At block 102, when types and/or quantities of the current state parameters meet a first preset condition, a first motion control policy is acquired by inputting the current state parameters into a first model generated by training.

At block 103, when the types and/or the quantities of the current state parameters do not meet the first preset condition, a second motion control policy is acquired by inputting the current state parameters into a second model generated by training.

Based on the description of block 101, it may be understood that for different types or the same type of multi-legged robots, the acquired state parameters may vary depending on the types and the quantities of the sensors.

For example, for the quadruped robot, the acquired state parameters may include angles and angular velocities of the twelve joints, positions of the four feet, forces stressed on the four feet, the speed of the torso, and the data of the inertial sensor, etc., respectively. Alternatively, the acquired state parameters may include partial parameters of the above parameters, for example, the angles and the angular velocities of the twelve joints, the positions of the four feet, the forces stressed on the four feet, and the data of the inertial sensor, etc.

Since configuration of the sensors of the multi-legged robot in a real scene may vary, or due to failure of the sensors of the multi-legged robot and other reasons, the types and/or the quantities of the state parameters acquired at different time points may be different for the same type of the multi-legged robot. Therefore, in the disclosure, a corresponding control policy may be adopted based on the types and/or the quantities of the acquired state parameters.

In an embodiment of the disclosure, when the types and/or the quantities of the acquired state parameters of the multi-legged robot meet the first preset condition, based on the current state parameters, the first motion control policy is acquired through the first model generated by training. When the types and/or the quantities of the acquired state parameters of the multi-legged robot do not meet the first preset condition, based on the current state parameters of the multi-legged robot, the second motion control policy is acquired through the second model generated by training.

For example, for the quadruped robot, the first preset condition may be pre-configured that the current state parameters of the quadruped robot include a 12-dimensional joint angle vector, a 12-dimensional joint angular velocity vector, a 4-dimensional foot position vector, a 4-dimensional foot force vector, a 3-dimensional torso speed vector, and a 6-dimensional inertial sensor data vector. When the acquired current state parameters of the quadruped robot include all of the foregoing data, the first motion control policy may be acquired by the trained first model based on the current state parameters of the quadruped robot.

Alternatively, when the acquired current state parameters of the quadruped robot include partial parameters of the 12-dimensional joint angle vector, the 12-dimensional joint angular velocity vector, the 4-dimensional foot position vector, the 4-dimensional foot force vector, the 3-dimensional torso speed vector, and the 6-dimensional inertial sensor data vector, the second motion control policy may be acquired by the trained second model based on the current state parameters of the quadruped robot.

In an embodiment of the disclosure, the first model and the second model generated by training may be any type of neural network model, and the first motion control policy and the second motion control policy output by the first model and the second model may be a foot trajectory of a desired motion of the multi-legged robot, or a joint angle of the desired motion of the multi-legged robot.

It is noted that the above example is illustrative and may not be a limitation of the first preset condition, the first model, and the second model in embodiments of the disclosure.

At block 104, the multi-legged robot is controlled based on the first motion control policy.

At block 105, the multi-legged robot is controlled based on the second motion control policy.

In an embodiment of the disclosure, when the first motion control policy and the second motion control policy each is the foot trajectories of the desired motion of the multi-legged robot, the foot trajectory may be converted to the joint angle based on an inverse kinematics solving method, and the joint angle is input into a bottom-layer motion controller, and a desired joint torque is output by the bottom-layer motion controller, further to control the joint of the multi-legged robot to move. When a target control policy is the joint angle of the desired motion of the multi-legged robot, the joint angle may be directly input into the bottom-layer motion controller, and the desired joint torque is output by the bottom-layer motion controller, further to control the joint of the multi-legged robot to move.

It should be noted that, based on whether the types and/or the quantities of the state parameters meet the first preset condition, execute one of block 104 and block 105.

According to the method for controlling the multi-legged robot in an embodiment of the disclosure, the current target control policy is acquired by acquiring the current state parameters of the multi-legged robot and selecting an applicable model based on the types and/or the quantities of the current state parameters of the multi-legged robot, thus achieving the motion control of the multi-legged robot. Based on the types and/or the quantities of the acquired state parameters of the multi-legged robot, the corresponding model is adopted to generate the control policy to control the motion of the multi-legged robot, so as to ensure stability and reliability of the motion of the multi-legged robot.

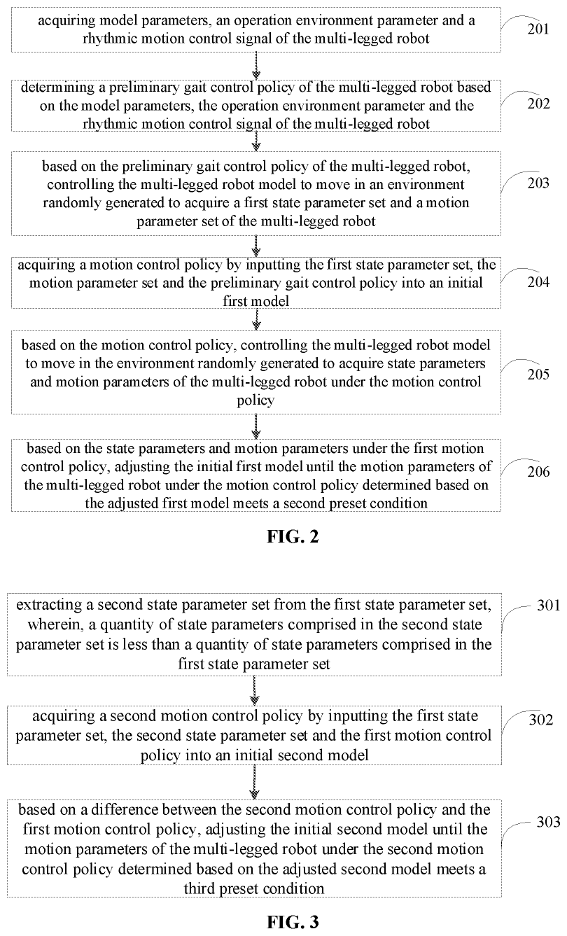

FIG. 2 is a flowchart illustrating a method for controlling a multi-legged robot according to another embodiment of the disclosure. As illustrated in FIG. 2, on the basis of embodiments as illustrated in FIG. 1, generating the first model by training may include the following blocks.

At block 201, model parameters, an operation environment parameter and a rhythmic motion control signal of the multi-legged robot are acquired.

In an embodiment of the disclosure, the multi-legged robot may be any type of robot with a walking function, such as a quadruped robot, a hexapod robot, an eight-legged robot, and other types of robots. For different types of robots, the acquired model parameters of the robot are different.

For example, the model parameters of the quadruped robot may include a torso and four limbs of the robot. Each limb may include three degree-of-freedom (DOF) joints including two hip joints and one knee joint. Therefore, the limbs of the quadruped robot totally have twelve DOF joints including eight hip joints and four knee joints.

Or the model parameters of the hexapod robot may include parameters of a torso and six limbs of the robot. Each limb may include three DOF joints including two hip joints and one knee joint. Therefore, the limbs of the hexapod robot have eighteen DOF joints including twelve hip joints and six knee joints.

In an embodiment of the disclosure, the motion environment of the multi-legged robot may include different terrains such as a flat ground, upstairs, downstairs, upslope, and downslope. The environment parameters of going upstairs and downstairs may be configured as different heights of stairs, for example, the height of the stairs may be 5 cm or 10 cm. Similarly, the environment parameters of going upslope and downslope may be configured as different gradients of slope, for example, the gradient of slope may be 30° or 60°.

A rhythmic motion may be a rhythmic and regular motion of an animal. The multi-legged robot is a kind of bionic robot, and a gait of which in a normal environment has a characteristic of the rhythmic motion. For different types of multi-legged robots, their motion gaits are different. For the same type of robot, there may be a plurality of gaits during motion. Therefore, in embodiments of the disclosure, for different types of multi-legged robots, the acquired rhythmic motion control signals are different.

For example, for the quadruped robot, the gait of the quadruped robot during motion may be that feet diagonally opposite output a same action synchronously, and two pairs of feet sequentially act at an interval of half period to complete one-time motion, and a phase difference between the two pairs of feet is the half period. For another example, the four feet of the quadruped robot sequentially output actions to complete one-time motion, and a phase difference between any two adjacent phases in the phases of the four feet is one quarter of the period.

Alternatively, for the hexapod robot, the gait of the hexapod robot during motion is a tripod gait, that is, three pairs of feet are divided into two groups, front and rear feet at one side and a middle foot at the other side are a group to form a triangular support structure, and the hexapod robot alternately moves with the triangular support structure during motion.

Therefore, the rhythmic motion control signal of the multi-legged robot may be determined based on the model parameters of the multi-legged robot and the configured motion gait, and the multi-legged robot moves based on the configured gait under an action of the rhythmic motion control signal.

It should be noted that the above example is illustrative and may not be a limitation of the model parameters, the operation environment parameter and the rhythmic motion control signal of the multi-legged robot in the embodiments of the disclosure.

At block 202, a preliminary gait control policy of the multi-legged robot is determined based on the model parameters, the operation environment parameter and the rhythmic motion control signal of the multi-legged robot.

On the basis of the description of block 201, in an embodiment of the disclosure, the operation environment parameter of the multi-legged robot may include a plurality of terrain parameters, such as include different terrain parameters like the flat ground, the upstairs, the downstairs, the upslope, and the downslope. In different terrains, the multi-legged robot moves in different ways. Therefore, in an embodiment of the disclosure, the preliminary gait control policies of the multi-legged robot respectively may include the preliminary gait control policy corresponding to each type of terrain.

Determining the preliminary gait control policy of the multi-legged robot corresponding to each type of terrain may include taking the rhythmic motion control signal as the current gait control policy to control a corresponding multi-legged robot to move under the terrains of the flat ground, the upstairs, the downstairs, the upslope, and the downslope, respectively, and then adjusting the current gait control policy under each terrain to acquire a final preliminary gait control policy.

A preliminary gait control policy for the multi-legged robot moving on the flat ground is determined, and based on the current gait control policy, and the multi-legged robot may be controlled to move on the flat ground to acquire motion parameters of the multi-legged robot. A fitness reward function is set based on the motion parameters of the multi-legged robot, and a fitness reward value acquired by the multi-legged robot for each motion is calculated based on the fitness reward function. The current gait control policy is adjusted based on the fitness reward value until the fitness reward value reaches a preset threshold.

The fitness reward function may be set as f=w₁*a₁+w₂*a₂+ . . . +wₘ*aₘ, where a₁, a₂, . . . aₘ denote reward factors, w₁, w₂, . . . wₘ each denote reward weights, m denotes a quantity of the reward factors, and the reward weights of respective reward factors may be set according to requirements.

For example, the motion parameters of the multi-legged robot may include a walking distance, stability of the gait, a forward distance of the foot, etc. The fitness reward function may be f=w₁*a₁+w₂* a₂+w₃a₃, where a₁, a₂, a₃ respectively denote the walking distance of the multi-legged robot, the stability of the gait, the forward distance of the foot, w₁, w₂, w₃ denote the reward weights corresponding to the foregoing motion parameters respectively, w₁, w₂, w₃ are respectively set to 0.3, 0.4, 0.3.

It should be noted that the above examples are illustrative and may not be a limitation of the motion parameters and the reward functions of the multi-legged robot in embodiments of the disclosure.

In embodiments of the disclosure, the preliminary gait control policies for the multi-legged robot going upstairs and downstairs are determined, and based on the current gait control policy, the multi-legged robot may be controlled to go upstairs and downstairs to acquire the motion parameters of the multi-legged robot. The fitness reward function is set based on the motion parameters of the multi-legged robot, and the fitness reward value acquired by the multi-legged robot for each motion is calculated based on the fitness reward function. The current gait control policy is adjusted based on the fitness reward value until the fitness reward value reaches the preset threshold.

The fitness reward function adopted when the preliminary gait control policies for the multi-legged robot going upstairs and downstairs are acquired may be set by referring to that adopted when the preliminary gait control policy for the multi-legged robot moving on the flat ground is acquired, which are not described herein.

It should be noted that since the stairs have a certain height, the multi-legged robot may be controlled to sequentially move on stairs with different heights when acquiring the preliminary gait control policies for the multi-legged robot going upstairs and downstairs. By gradually increasing the height of the stairs, the preliminary gait control policies for the multi-legged robot going upstairs and downstairs may be gradually optimized, to finally achieve an effect of climbing up the stairs with a specific height.

For example, the multi-legged robot is controlled to climb up stairs with a height of 3 cm based on the current gait control policy, and the current gait control policy is adjusted based on the above description process. Based on the adjusted current gait control policy, the multi-legged robot is controlled to climb up stairs with a height of 5 cm, and the current gait control policy continues to be adjusted based on the above description process, so as to gradually increase the height of the stairs until the multi-legged robot may climb up stairs with a height of 10 cm.

Similarly, in embodiments of the disclosure, preliminary gait control policies for the multi-legged robot moving upslope and downslope are determined, and based on the current gait control policy, the multi-legged robot may be controlled to move upslope and downslope to acquire the motion parameters of the multi-legged robot. The fitness reward function is set based on the motion parameters of the multi-legged robot, and the fitness reward value acquired by the multi-legged robot for each motion is calculated based on the fitness reward function. The current gait control policy is adjusted based on the fitness reward value until the fitness reward value reaches the preset threshold.

The fitness reward function adopted when the preliminary gait control policies of the multi-legged robot moving upslope and downslope is acquired may be set by referring to that adopted when the preliminary gait control policy for the multi-legged robot moving on the flat ground is acquired, which are not described herein.

It should be noted that, since the slopes have different gradients, the multi-legged robot may be controlled to successively move slopes with different gradients when acquiring preliminary gait control policies for the multi-legged robot moving upslope and downslope. By gradually increasing the gradient of the slope, the preliminary gait control policies for the multi-legged robot moving upslope and downslope may be gradually optimized, to finally achieve an effect of climbing up a slope with a specific gradient.

For example, the multi-legged robot is controlled to climb up a slope with a gradient of 10° based on the current gait control policy, and the current gait control policy is adjusted based on the above description process. Based on the adjusted current gait control policy, the multi-legged robot is controlled to climb up a slope with a gradient of 30°, and the current gait control policy continues to be adjusted based on the above description process, so as to gradually increase the gradient of the slope until the multi-legged robot may climb a slope with a gradient of 60°.

It should be noted that the above examples are illustrative and may not be a limitation of the operation environment parameters in embodiments of the disclosure.

At block 203, based on the preliminary gait control policy of the multi-legged robot, the multi-legged robot is controlled to move in an environment randomly generated to acquire a first state parameter set and a motion parameter set of the multi-legged robot.

In embodiments of the disclosure, the environment randomly generated may include one or more of different terrains such as the flat ground, the upstairs, the downstairs, the upslope, and the downslope.

For example, the environment randomly generated may be first upstairs, then flat ground and finally downslope. Alternatively, the environment randomly generated may be first downstairs, then upslope, then flat ground, and finally upstairs.

The multi-legged robot model moves in the environment randomly generated, and the acquired first posture parameter set may include different types of state parameters at each time point of the plurality of time points during the motion process of the multi-legged robot.

For example, for the quadruped robot, the first posture parameter set may include Oₜ₋ₙ, Oₜ₋ₙ₊1, . . . , Oₜ, where t denotes a current time point, Oᵢ denotes the state parameters at an i-th time point, i=t−n, t−n+1, . . . , t. Oᵢ may include a 12-dimensional joint angle vector, a 12-dimensional joint angular velocity vector, a 4-dimensional foot position vector, a 4-dimensional foot force vector, a 3-dimensional torso velocity vector, and a 6-dimensional inertial sensor data vector of the multi-legged robot at the i-th time point.

The multi-legged robot model moves in the environment randomly generated, and may acquire different types of motion parameters of the multi-legged robot at each of the plurality of time points based on the state parameters of the multi-legged robot model at each time point.

For example, for the quadruped robot, the motion parameter set may include Sₜ₋ₙ, Sₜ₋ₙ₊1, . . . , Sₜ, where, t denotes a current time point, Sᵢ denotes a motion parameter at an i-th time point, i=t−n, t−n+1, . . . , t. Sᵢ may include a torso displacement, posture stability, a foot displacement, yaw and roll, energy loss of the multi-legged robot at the i-th time point.

At block 204, a motion control policy is acquired by inputting the first state parameter set, the motion parameter set and the preliminary gait control policy into an initial first model.

In embodiments of the disclosure, an initial first motion control policy may be acquired by inputting the first state parameter set, the motion parameter set and the preliminary gait control policy into an initial first model.

It should be noted that, a control signal output by the preliminary gait control policy is a desired foot trajectory or a desired joint angle when the multi-legged robot moves under a certain terrain. Under the action of the preliminary gait control policy, the multi-legged robot moves in the environment randomly generated, and the foot trajectory or the joint angle of the actual motion of the multi-legged robot may have a difference with the desired foot trajectory or the desired joint angle of the preliminary gait control policy, which may cause gait instability or even falling of the multi-legged robot when moving.

In embodiments of the disclosure, the initial first model may be any type of neutral network model. The motion control policy configured to control the motion of the multi-legged robot may be generated based on the acquired preliminary gait control policy, the state parameters and the motion parameters.

At block 205, based on the motion control policy, the multi-legged robot is controlled to move in the environment randomly generated to acquire state parameters and motion parameters of the multi-legged robot under the motion control policy.

In embodiments of the disclosure, based on the initial first motion control policy, the multi-legged robot model is controlled to move in the environment randomly generated to acquire state parameters and motion parameters of the multi-legged robot under the initial first motion control policy.

Based on the description of block 203, the environment randomly generated may include one or more of different terrains such as the flat ground, the upstairs, the downstairs, the upslope, and the downslope. For example, the environment randomly generated may be first upstairs, then flat ground and finally downslope. Alternatively, the environment randomly generated may be first downstairs, then upslope, then flat ground, finally upstairs.

The multi-legged robot may move in the environment randomly generated under the action of the motion control policy. The state parameters may include the joint angle vector, the joint angular velocity vector, the foot position vector, the foot force vector, the torso velocity vector, and the inertial sensor data vector. The acquired motion parameters may include a torso displacement, posture stability, a foot displacement, yaw and roll, energy loss, etc.

At block 206, based on the state parameters and the motion parameters acquired under the motion control policy, the initial first model is adjusted until the motion parameters of the multi-legged robot under the motion control policy determined based on the adjusted first model meets a second preset condition.

In embodiments of the disclosure, based on the state parameters and motion parameters under the initial first motion control policy, the initial first model is adjusted. It is continued to determine an adjusted first motion control strategy based on an adjusted first model and to determine motion parameters under the adjusted first motion control strategy based on the adjusted first motion control strategy, until the motion parameters of the multi-legged robot under the adjusted first motion control policy meets the second preset condition.

In embodiments of the disclosure, generating the first model by training to determine the motion control policy output by the first mode may include: setting a reward function based on the motion parameters of the multi-legged robot; and calculating a reward obtained by the multi-legged robot executing operations under the action of the current motion control policy based on the reward function; adjusting the current motion control policy based on the reward until the reward reaches a preset threshold, that is, the motion parameters meet the second preset condition.

For example, a reward function R=p₁*f₁+p₂*f₂+ . . . +pₓ*fₓ may be preset, where, f₁, f₂, . . . fₓ denote respective reward items, p₁, p₂, . . . pₓ denote respective reward weights, x is a quantity of the reward items, and a reward weight of each reward item may be preset based on requirements.

For example, the motion parameters of the multi-legged robot may include the torso displacement, the posture stability, the foot displacement, the yaw and roll, the energy loss, etc. The reward function may be preset as R=p₁*f₁+p₂*f₂+p₃*f₃+p₄*f₄+p₅*f₅+p₆*f₆, where f₁, f₂, f₃, f₄, f₅, f₆ respectively denote the torso displacement, the posture stability, the foot displacement, the yaw and roll, the energy loss, p₁, p₂, p₃, p₄, p₅, p₆ is reward weights corresponding to respective motion parameters, and the values of p₁, p₂, p₃, p₄, p₅, p₆ may be set to 0.1, 0.2, 0.3, 0.1, 0.1, 0.2, respectively.

It should be noted that the above examples are illustrative and may not be a limitation of the state parameters, the motion parameters and the reward functions of the multi-legged robot in embodiments of the disclosure.

In embodiments of the disclosure, determining a final motion control policy of the first model may include controlling the multi-legged robot to move based on the initial motion control policy, to acquire the state parameters and the motion parameters of the multi-legged robot; setting the reward function based on the motion parameters of the multi-legged robot, and calculating the reward acquired by the multi-legged robot for each motion based on the reward function; adjusting the current motion control policy based on the reward until the reward reaches the preset threshold, at this time, the motion of the multi-legged robot reaches a desired effect.

In embodiments of the disclosure, the first model may be generated by simulating the multi-legged robot in a simulation environment based on the simulation environment, or may also be generated by constructing a physical robot and building a real scene.

For example, a multi-legged robot model and an environment model may be built using a Pybullet simulation environment, or a Gazebo simulation environment, etc. Related parameters are set in the simulation environment to construct the robot model, which may include a torso structure and limb structures of the multi-legged robot, the quantities and the types of the sensors arranged at respective parts of the multi-legged robot, etc. Related parameters are set in the simulation environment to construct the environment model, which may include different terrains and parameters of the terrain.

Alternatively, mechanical components and electronic components may be configured to construct the physical multi-legged robot, and the sensors are mounted at respective parts of the multi-legged robot, so as to acquire the state information of the multi-legged robot. Meanwhile, a motion environment including different terrains is constructed in the real scene for actual motion of the multi-legged robot.

Based on the method for controlling the multi-legged robot according to embodiment of the disclosure, the preliminary gait control policies of the multi-legged robot under different terrains are acquired, and the multi-legged robot is controlled to move in the environment randomly generated based on the preliminary gait control policies, and then the motion control policy is optimized based on the motion parameters of the multi-legged robot, such that the final output motion control policy may achieve a desired motion effect, which effectively improves stability and reliability of the multi-legged robot in the complex terrain environment.

FIG. 3 is a flowchart illustrating a method for controlling a multi-legged robot according to another embodiment of the disclosure. As illustrated in FIG. 3, on the basis of embodiments as illustrated in FIG. 2, generating the second model by training may include the following blocks.

At block 301, a second state parameter set is extracted from the first state parameter set. A quantity of state parameters included in the second state parameter set is less than a quantity of state parameters included in the first state parameter set.

Based on the description of other embodiments of the disclosure, for different types of robots and types and quantities of sensors arranged at different parts of the robot, the acquired state parameters of the robot are different.

For example, for the quadruped robot, the first state parameter set may include a 12-dimensional joint angle vector, a 12-dimensional joint angular velocity vector, a 4-dimensional foot position vector, a 4-dimensional foot force vector, a 3-dimensional torso velocity vector, and a 6-dimensional inertial sensor data vector. The second posture parameter set is extracted from the first posture parameter set, and may include the 12-dimensional joint angle vector, the 12-dimensional joint angular velocity vector, the 4-dimensional foot position vector, the 4-dimensional foot force vector and the 6-dimensional inertial sensor data vector.

At block 302, a second motion control policy is acquired by inputting the first state parameter set, the second state parameter set and the first motion control policy into an initial second model.

In embodiments of the disclosure, an initial second motion control policy is acquired by inputting the first state parameter set, the second state parameter set and the first motion control policy finally determined based on the second preset condition into an initial second model.

It is noted that, the first motion control policy may be acquired based on the first state parameter set of the multi-legged robot. In a real scene, due to a limitation of a plurality of conditions, partial state parameters of the multi-legged robot may be acquired, which may result in that the first motion control policy is impossible to be applied to the multi-legged robot in some situations.

Therefore, in embodiments of the disclosure, partial parameters are extracted from the first state parameter set to form the second state parameter set, and the initial second model may make the acquired second motion control policy similar to the first motion control policy, based on the first posture parameter set and the second state parameter set, by simulating the first motion control policy.

For example, the first state parameter set Oₜ may be defined to include (y₁, y₂, y₃, y₄, y₅, y₆), and the second state parameter set O′ₜ may be defined to include (y₁, y₂, y₃, y₄, y₅), where, y₁, y₂, y₃, y₄, y₅, y₆ respectively denote the 12-dimensional joint angle vector, the 12-dimensional joint angular velocity vector, the 4-dimensional foot position vector, the 4-dimensional foot force vector, the 6-dimensional inertial sensor data vector and the 3-dimensional torso velocity vector. Assuming that the first motion control policy output by the first model π*(·|Oₜ) is a*ₜ, and based on (Oₜ, O′ₜ, a*ₜ), a second motion control policy aₜ output by a second model π′(·|O′ₜ) may be calculated by adopting an imitation learning method.

At block 303, based on a difference between the second motion control policy and the first motion control policy, the initial second model is adjusted until the motion state of the multi-legged robot under the second motion control policy determined based on the adjusted second model meets a third preset condition.

In embodiments of the disclosure, based on a difference between the initial second motion control policy and the first motion control policy finally determined based on the second preset condition, the initial second model is adjusted. It is continued to determine an adjusted second motion control strategy based on an adjusted second model, until a difference between the adjusted second motion control policy and the first motion control policy finally determined based on the second preset condition meets the third preset condition.

In embodiments of the disclosure, generating the second model by training and determining the second motion control policy may include defining a minimized target loss function when the second model performs simulation learning, and setting the third preset condition to be that a function value of the minimized target loss function reaches a preset threshold.

For example, the minimized target loss function L is defined as L=∥aₜ−a*ₜ∥₂, and based on (Oₜ, O′ₜ, a*ₜ), the second motion control policy aₜ output by the second model π′(·|O′ₜ) may be calculated by adopting the simulation learning method. The initial second model is adjusted based on the minimized target loss function L, and when the function value of the minimized target loss function meets the third preset condition, the second motion control policy output by the second model is acquired.

Based on the method for controlling the multi-legged robot according to embodiments of the disclosure, for the multi-legged robot capable of acquiring the first posture parameter set, the first model is generated by training, further the first motion control policy is determined. Then, for the multi-legged robot capable of acquiring the second posture parameter set, the second model is generated by training through using the simulation learning method, such that the second model may generate the second motion control policy based on the first motion control policy. Therefore, the control method provided by the disclosure may be applied to the multi-legged robot with different configuration conditions, and the method for controlling the multi-legged robot provided in the disclosure has better robustness and generalization.

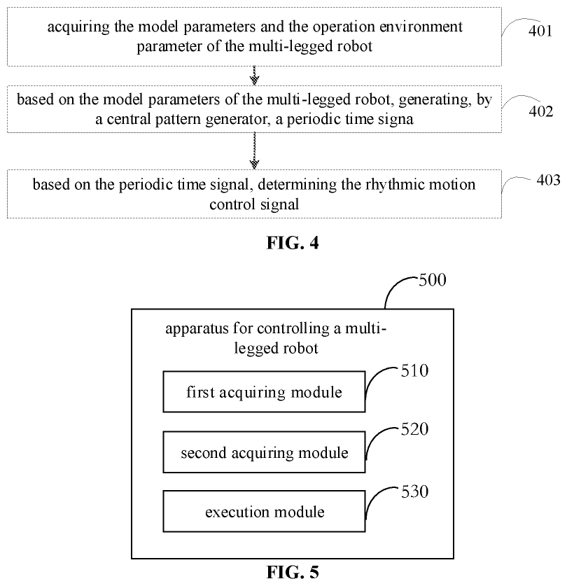

FIG. 4 is a flowchart illustrating a method for controlling a multi-legged robot according to another embodiment of the disclosure. As illustrated in FIG. 4, on the basis of embodiments as illustrated in FIG. 2, the block 201 that model parameters, an operation environment parameter and a rhythmic motion control signal of the multi-legged robot are acquired may include the following blocks:

At block 401, the model parameters and the operation environment parameter of the multi-legged robot are acquired.

It is noted that, the model parameters and the operation environment parameter of the multi-legged robot may be acquired at block 401 referring to the implementation mode at block 201, which are not repeated here.

At block 402, based on the model parameters of the multi-legged robot, a periodic time signal is generated by a central pattern generator.

The central pattern generator (CPG) is a distributed neutral network for controlling an animal to generate a rhythmic motion behavior. The CPG may generate a stable phase-locked periodic time signal in case of no rhythmic signal input, no feedback information, and absence of higher layer control commands.

For example, an initial input element and an operating mode of the CPG may be defined based on the model parameters of the multi-legged robot.

For example, two initial input elements x₀, x₁ of the CPG may be defined, where, initial values of x₀, x₁ are x₀=sin(0)=0, x₁=cos(0)=1, respectively, that is, the two elements differ by 0.5 phases. The operating mode of the CPG network is x^{t}=[x₀^{t}, x₁^{t}], x^{t+Δt}=w(Δt)* x^{t}, where, a rotation matrix

$$w ( Δ t ) = [ \begin{matrix}sin ( θ Δ t ) & cos ( θ Δ t ) \\ - cos ( θΔt ) & sin ( θ Δ t )\end{matrix} ] ,$$

θ denotes a rotation angular velocity, that is, a frequency of the CPG network, and θΔt denotes a rotation angle within a time Δt. The initial input element may be calculated by integral of the CPG network to obtain x^{t}=[sin(θt), cos(θt)].

Then, an output x^{t} of the CPG network may be map to a high-dimensional feature vector through a radial basis function (RBF). Assuming that a dimension of the high-dimensional feature vector is H and a period time of a CPG network is T, H points [x^{h}^{₀}, x^{h}^{₁}, . . . , x^{h}^{_{H}}⁻¹] may be selected to obtain the periodic time signal vⁱ(t)=e^{-α(x}^{^{t}}^{-x}^{^{h}}ⁱ), where

$${h}_{i} = \frac{i}{H - 1} T ,$$

i=0,1, . . . , H−1, vⁱ(t) denotes an H-dimensional feature vector, e denotes a natural index, and α denotes an adjustable parameter.

At block 403, based on the periodic time signal, the rhythmic motion control signal is determined.

Mapping the periodic time signal to the rhythmic motion control signal may include setting a mapping function based on a motion gait of the multi-legged robot.

For example, a type of gait of a quadruped robot is that feet diagonally opposite output a same action synchronously, and a phase difference between two pairs of feet is half period. Thus, the periodic time signal vⁱ(t) may be mapped to the rhythmic motion control signal uₜ=ω*vⁱ(t)+b of one foot of the quadruped robot, where, ω denotes a matrix with a dimension of (3, H), b denotes a vector with a dimension of 3, ω and b denote trainable network parameters.

Assuming that the one foot is a first foot of the quadruped robot, a foot diagonally opposite to the first foot is a third foot, and the other pair of feet diagonally opposite of the quadruped robot are a second foot and a fourth foot, in this case, the rhythmic motion control signal of the third foot of the quadruped robot is the same as the rhythmic motion control signal of the first foot, the rhythmic motion control signal of the second foot of the quadruped robot is the same as the rhythmic motion control signal of the fourth foot, and the phase difference between the rhythmic motion control signal of the second foot and the fourth foot and the rhythm motion control signal of the first foot is half period. Based on the rhythmic motion control signal of the first foot, rhythmic motion control signals of other feet of the quadruped robot may be obtained.

Based on the method for controlling the multi-legged robot provided in embodiment of the disclosure, the rhythmic motion control signal of the multi-legged robot is generated based on the CPG, thereby avoiding establishing an accurate multi-legged robot model and artificially designing an initial control policy, effectively reducing workload of acquiring the method for controlling the multi-legged robot, and reducing complexity of acquiring the method for controlling the multi-legged robot.

According to embodiments of the disclosure, an apparatus for controlling a multi-legged robot is provided.

FIG. 5 is a block diagram illustrating an apparatus for controlling a multi-legged robot according to an embodiment of the disclosure. As illustrated in FIG. 5, the apparatus 500 for controlling the multi-legged robot includes a first acquiring module 510, a second acquiring module 520 and an execution module 530.

The first acquiring module 510 is configured to acquire current state parameters of the multi-legged robot.

The second acquiring module 520 is configured to, when types and/or quantities of the current state parameters meet a first preset condition, acquire a first motion control policy by inputting the current state parameters into a first model generated by training; or when the types and/or the quantities of the current state parameters do not meet the first preset condition, acquire a second motion control policy by inputting the current state parameters into a second model generated by training.

The execution module 530 is configured to control the multi-legged robot based on the first motion control policy; or control the multi-legged robot based on the second motion control policy.

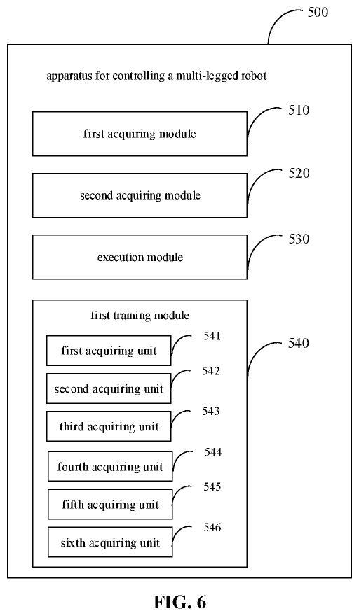

In a possible implementation, as illustrated in FIG. 6, on the basis of embodiments as illustrated in FIG. 5, the apparatus further includes a first training module 540. The first training module 540 includes a first acquiring unit 541, a second acquiring unit 542, a third acquiring unit 543, a fourth acquiring unit 544, a fifth acquiring unit 545, and a sixth acquiring unit 546.

The first acquiring unit 541 is configured to acquire model parameters, an operation environment parameter and a rhythmic motion control signal of the multi-legged robot. The second acquiring unit 542 is configured to determine a preliminary gait control policy of the multi-legged robot based on the model parameters, the operation environment parameter and the rhythmic motion control signal of the multi-legged robot. The third acquiring unit 543 is configured to, based on the preliminary gait control policy of the multi-legged robot, control the multi-legged robot model to move in an environment randomly generated to acquire a first state parameter set and a motion parameter set of the multi-legged robot. The fourth acquiring unit 544 is configured to acquire a first motion control policy by inputting the first state parameter set, the motion parameter set and the preliminary gait control policy into an initial first model. The fifth acquiring unit 545 is configured to, based on the first motion control policy, control the multi-legged robot model to move in the environment randomly generated to acquire state parameters and motion parameters of the multi-legged robot under the first motion control policy. The sixth acquiring unit 546 is configured to, based on the state parameters and motion parameters under the first motion control policy, adjust the initial first model until the motion parameters of the multi-legged robot under the first motion control policy determined based on the adjusted first model meets a second preset condition.

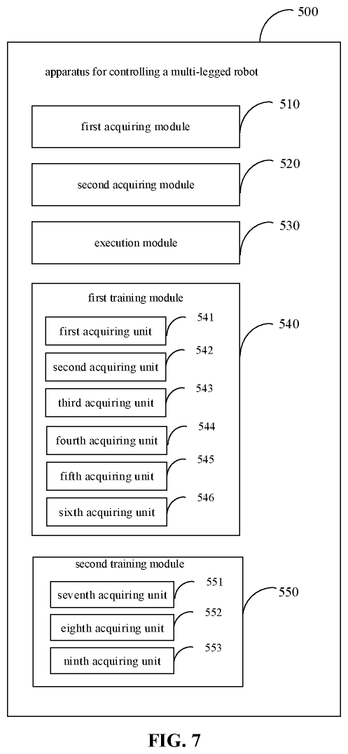

In a possible implementation, as illustrated in FIG. 7, on the basis of embodiments as illustrated in FIG. 6, the apparatus further includes a second training module 550. The second training module 550 includes a seventh acquiring unit 551, an eighth acquiring unit 552 and a ninth acquiring unit 553.

The seventh acquiring unit 551 is configured to extract a second state parameter set from the first state parameter set, wherein, a quantity of state parameters comprised in the second state parameter set is less than a quantity of state parameters comprised in the first state parameter set. The eighth acquiring unit 552 is configured to acquiring a second motion control policy by inputting the first state parameter set, the second state parameter set and the first motion control policy into an initial second mode. The ninth acquiring unit 553 is configured to, based on a difference between the second motion control policy and the first motion control policy, adjust the initial second model until the motion parameters of the multi-legged robot under the second motion control policy determined based on the adjusted second model meets the third preset condition.

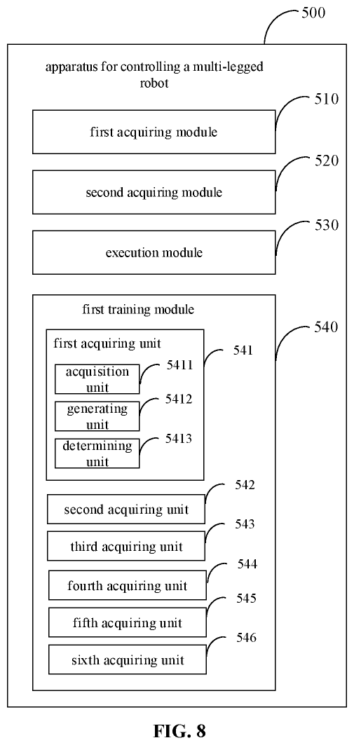

In a possible implementation, as illustrated in FIG. 8, on the basis of embodiments as illustrated in FIG. 6, the first acquiring unit 541 includes: an acquisition unit 5411, a generating unit 5412 and a determining unit 5413.

The acquisition unit 5411 is configured to acquire the model parameters and the operation environment parameter of the multi-legged robot. The generating unit 5412 is configured to, based on the model parameters of the multi-legged robot, generate, by a central pattern generator, a periodic time signal. The determining unit 5413 is configured to, based on the periodic time signal, determine a rhythmic motion control signal.

It should be noted that, the description of embodiments of the method for controlling the multi-legged robot is applied to the apparatus for controlling the multi-legged robot, which will not be repeated here.

The apparatus for controlling the multi-legged robot in embodiments of the disclosure acquires a current target control policy by acquiring the current state parameters of the multi-legged robot and selecting an applicable model based on the types and/or the quantities of the current state parameters of the multi-legged robot, thereby achieving motion control of the multi-legged robot. Based on the types and/or the quantities of the acquired state parameters of the multi-legged robot, the corresponding model is adopted to generate the control policy to control the motion of the multi-legged robot, so as to ensure stability and reliability of the motion of the multi-legged robot.

According to embodiments of the disclosure, the disclosure further provides an electronic device, a readable storage medium and a computer program product.

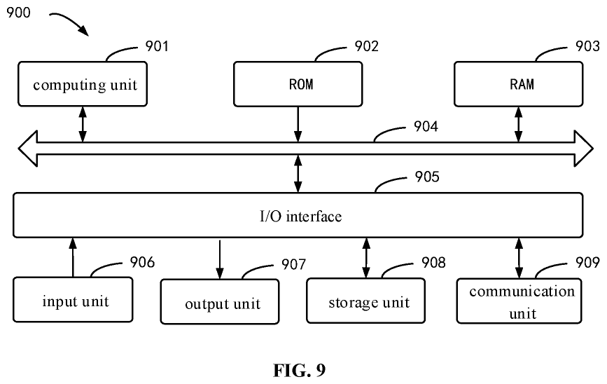

FIG. 9 illustrates a schematic block diagram of an example electronic device 900 configured to implement the embodiment of the disclosure. An electronic device is intended to represent various types of digital computers, such as laptop computers, desktop computers, workstations, personal digital assistants, servers, blade servers, mainframe computers, and other suitable computers. An electronic device may also represent various types of mobile apparatuses, such as personal digital assistants, cellular phones, smart phones, wearable devices, and other similar computing devices. The components shown herein, their connections and relations, and their functions are merely examples, and are not intended to limit the implementation of the disclosure described and/or required herein.

As illustrated in FIG. 9, the device 900 includes a computing unit 901, which may execute various appropriate actions and processings based on a computer program stored in a read-only memory (ROM) 902 or a computer program loaded into a random access memory (RAM) 903 from a storage unit 908. In the RAM 903, various programs and data required for operation of the device 900 may also be stored. The computing unit 901, the ROM 902, and the RAM 903 are connected to each other through a bus 904. An input/output (I/O) interface 905 is also connected to a bus 904.

Several components in the device 900 are connected to the I/O interface 905, and include: an input unit 906, for example, a keyboard, a mouse, etc.; an output unit 907, for example, various types of displays, speakers, etc.; a storage unit 908, for example, a magnetic disk, an optical disk, etc.; and a communication unit 909, for example, a network card, a modem, a wireless communication transceiver, etc. The communication unit 909 allows the device 900 to exchange information/data with other devices over a computer network such as the Internet and/or various telecommunication networks.

The computing unit 901 may be various general-purpose and/or special-purpose processing components with processing and computing capacities. Some examples of the computing unit 901 include but are not limited to a central processing unit (CPU), a graphics processing unit (GPU), various dedicated artificial intelligence (AI) computing chips, various computing chips running a machine learning model algorithm, a digital signal processor (DSP), and any suitable processor, controller, microcontroller, or etc. The computing unit 901 performs various methods and processings described above, for example, a method for controlling a multi-legged robot. For example, in some embodiments, a method for controlling a multi-legged robot may be implemented as a computer software program tangibly included in a machine-readable medium, such as a storage unit 908. In some embodiments, some or all of the computer programs may be loaded and/or mounted on the device 900 via a ROM 902 and/or a communication unit 909. When the computer programs are loaded in a RAM 903 and performed by a computing unit 901, one or more blocks of the above method for controlling a multi-legged robot may be performed. Alternatively, in other embodiments, the computing unit 901 may be configured to perform the method for controlling a multi-legged robot by any other suitable means (for example, by means of a firmware).

Various implementation modes of the systems and technologies described above may be implemented in a digital electronic circuit system, a field programmable gate array (FPGA), an application-specific integrated circuit (ASIC), an application specific standard product (ASSP), a system-on-chip (SOC) system, a complex programmable logic device, a computer hardware, a firmware, a software, and/or combinations thereof. The various implementation modes may include: being implemented in one or more computer programs, the one or more computer programs may be executed and/or interpreted on a programmable system including at least one programmable processor, the programmable processor may be a dedicated or a general-purpose programmable processor that may receive data and instructions from a storage system, at least one input apparatus, and at least one output apparatus, and transmit the data and instructions to the storage system, the at least one input apparatus, and the at least one output apparatus.

A computer code configured to execute a method in the present disclosure may be written with one or any combination of a plurality of programming languages. The programming languages may be provided to a processor or a controller of a general-purpose computer, a dedicated computer, or other apparatuses for programmable data processing so that the function/operation specified in the flowchart and/or block diagram may be performed when the program code is executed by the processor or controller. A computer code may be performed completely or partly on the machine, performed partly on the machine as an independent software package and performed partly or completely on the remote machine or server.

In the context of the disclosure, a machine-readable medium may be a tangible medium that may contain or store a program intended for use in or in conjunction with an instruction execution system, apparatus, or device. A machine-readable medium may be a machine-readable signal medium or a machine-readable storage medium. A machine-readable storage medium may include but not limited to an electronic, magnetic, optical, electromagnetic, infrared, or semiconductor system, apparatus or device, or any appropriate combination thereof. A more specific example of a machine readable storage medium includes an electronic connector with one or more cables, a portable computer disk, a hardware, a random access memory (RAM), a read-only memory (ROM), an erasable programmable read-only memory (an EPROM or a flash memory), an optical fiber device, and a portable optical disk read-only memory (CDROM), an optical storage device, a magnetic storage device, or any appropriate combination of the above.

In order to provide interaction with a user, the systems and technologies described here may be implemented on a computer, and the computer has: a display apparatus for displaying information to a user (for example, a CRT (cathode ray tube) or a LCD (liquid crystal display) monitor); and a keyboard and a pointing apparatus (for example, a mouse or a trackball) through which the user may provide input to the computer. Other types of apparatuses may further be configured to provide interaction with the user; for example, the feedback provided to the user may be any form of sensory feedback (for example, visual feedback, auditory feedback, or tactile feedback); and input from the user may be received in any form (including an acoustic input, a voice input, or a tactile input).

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation mode of the system and technology described herein), or a computing system including any combination of such back-end components, middleware components or front-end components. The system components may be connected to each other through any form or medium of digital data communication (for example, a communication network). Examples of communication networks include: a local area network (LAN), a wide area network (WAN), an internet and a blockchain network.

The computer system may include a client and a server. The client and server are generally far away from each other and generally interact with each other through a communication network. The relationship between the client and the server is generated by computer programs running on the corresponding computer and having a client-server relationship with each other. A server may be a cloud server, also known as a cloud computing server or a cloud host, is a host product in a cloud computing service system, to solve the shortcomings of large management difficulty and weak business expansibility existed in the conventional physical host and Virtual Private Server (VPS) service. A server further may be a server with a distributed system, or a server in combination with a blockchain.

It should be understood that various forms of procedures shown above may be configured to reorder, add or delete blocks. For example, blocks described in the disclosure may be executed in parallel, sequentially, or in a different order, as long as the desired result of the technical solution disclosed in the present disclosure may be achieved, which will not be limited herein.

The above specific implementations do not constitute a limitation on the protection scope of the disclosure. Those skilled in the art should understand that various modifications, combinations, sub-combinations and substitutions may be made according to design requirements and other factors. Any modification, equivalent replacement, improvement, etc., made within the spirit and principle of embodiments of the present disclosure shall be included within the protection scope of the present disclosure.

What is claimed is:

1. A method for controlling a multi-legged robot, comprising:
acquiring current state parameters of the multi-legged robot;
when types and/or quantities of the current state parameters meet a first preset condition, acquiring a first motion control policy by inputting the current state parameters into a first model generated by training; and
controlling the multi-legged robot based on the first motion control policy.

2. The method of claim 1, after acquiring the current state parameters of the multi-legged robot, further comprising:
when the types and/or the quantities of the current state parameters do not meet the first preset condition, acquiring a second motion control policy by inputting the current state parameters into a second model generated by training; and
controlling the multi-legged robot based on the second motion control policy.

3. The method of claim 2, before inputting the current state parameters into the first model generated by training, further comprising:
acquiring model parameters, an operation environment parameter and a rhythmic motion control signal of the multi-legged robot;
determining a preliminary gait control policy of the multi-legged robot based on the model parameters, the operation environment parameter and the rhythmic motion control signal of the multi-legged robot;
based on the preliminary gait control policy of the multi-legged robot, controlling the multi- legged robot model to move in an environment randomly generated to acquire a first state parameter set and a motion parameter set of the multi-legged robot;
acquiring an initial first motion control policy by inputting the first state parameter set, the motion parameter set and the preliminary gait control policy into an initial first model;
based on the initial first motion control policy, controlling the multi-legged robot model to move in the environment randomly generated to acquire state parameters and motion parameters of the multi-legged robot under the initial first motion control policy; and
based on the state parameters and motion parameters under the initial first motion control policy, adjusting the initial first model, and continuing to determine an adjusted first motion control strategy based on an adjusted first model and to determine motion parameters under the adjusted first motion control strategy based on the adjusted first motion control strategy, until the motion parameters of the multi-legged robot under the adjusted first motion control policy meets a second preset condition.

4. The method of claim 3, after based on the state parameters and the motion parameters under the initial first motion control policy, adjusting the initial first model, until the motion parameters of the multi-legged robot under the adjusted first motion control policy determined based on the adjusted first model meets the second preset condition, further comprising:
extracting a second state parameter set from the first state parameter set, wherein, a quantity of state parameters comprised in the second state parameter set is less than a quantity of state parameters comprised in the first state parameter set;
acquiring an initial second motion control policy by inputting the first state parameter set, the second state parameter set and the first motion control policy finally determined based on the second preset condition into an initial second model; and
based on a difference between the initial second motion control policy and the first motion control policy finally determined based on the second preset condition, adjusting the initial second model, and continuing to determine an adjusted second motion control strategy based on an adjusted second model, until a difference between the adjusted second motion control policy and the first motion control policy finally determined based on the second preset condition meets a third preset condition.

5. The method of claim 3, wherein acquiring the model parameters, the operation environment parameter and the rhythmic motion control signal of the multi-legged robot comprises:
acquiring the model parameters and the operation environment parameter of the multi-legged robot;
based on the model parameters of the multi-legged robot, generating, by a central pattern generator, a periodic time signal; and
based on the periodic time signal, determining the rhythmic motion control signal.

6. The method of claim 4, wherein acquiring the model parameters, the operation environment parameter and the rhythmic motion control signal of the multi-legged robot comprises:
acquiring the model parameters and the operation environment parameter of the multi-legged robot;
based on the model parameters of the multi-legged robot, generating, by a central pattern generator, a periodic time signal; and
based on the periodic time signal, determining the rhythmic motion control signal.

7. An apparatus for controlling a multi-legged robot, comprising:
at least one processor; and
a memory communicatively connected to the at least one processor; wherein,
the memory is stored with instructions executed by the at least one processor, the at least one processor is configured to:
acquire current state parameters of the multi-legged robot;
when types and/or quantities of the current state parameters meet a first preset condition, acquire a first motion control policy by inputting the current state parameters into a first model generated by training; and
control the multi-legged robot based on the first motion control policy.

8. The apparatus of claim 7, wherein the at least one processor is configured to:
when the types and/or the quantities of the current state parameters do not meet the first preset condition, acquire a second motion control policy by inputting the current state parameters into a second model generated by training; and
control the multi-legged robot based on the second motion control policy.

9. The apparatus of claim 8, wherein the at least one processor is configured to:
acquire model parameters, an operation environment parameter and a rhythmic motion control signal of the multi-legged robot;
determine a preliminary gait control policy of the multi-legged robot based on the model parameters, the operation environment parameter and the rhythmic motion control signal of the multi-legged robot;
based on the preliminary gait control policy of the multi-legged robot, control the multi-legged robot model to move in an environment randomly generated to acquire a first state parameter set and a motion parameter set of the multi-legged robot; and
acquire an initial first motion control policy by inputting the first state parameter set, the motion parameter set and the preliminary gait control policy into an initial first model;
based on the initial first motion control policy, control the multi-legged robot model to move in the environment randomly generated to acquire state parameters and motion parameters of the multi-legged robot under the initial first motion control policy; and
based on the state parameters and motion parameters under the initial first motion control policy, adjust the initial first model, and continue to determine an adjusted first motion control strategy based on an adjusted first model and to determine motion parameters under the adjusted first motion control strategy based on the adjusted first motion control strategy until the motion parameters of the multi-legged robot under the adjusted first motion control policy meets a second preset condition.

10. The apparatus of claim 9, wherein the at least one processor is configured to:
extract a second state parameter set from the first state parameter set, wherein, a quantity of state parameters comprised in the second state parameter set is less than a quantity of state parameters comprised in the first state parameter set;
acquiring an initial second motion control policy by inputting the first state parameter set, the second state parameter set and the first motion control policy finally determined based on the second preset condition into an initial second mode; and
based on a difference between the initial second motion control policy and the first motion control policy finally determined based on the second preset condition, adjust the initial second model, and continuing to determine an adjusted second motion control strategy based on an adjusted second model, until a difference between the adjusted second motion control policy and the first motion control policy finally determined based on the second preset condition meets a third preset condition.

11. The apparatus of claim 9, wherein the at least one processor is configured to:
acquire the model parameters and the operation environment parameter of the multi-legged robot;
based on the model parameters of the multi-legged robot, generate, by a central pattern generator, a periodic time signal; and
based on the periodic time signal, determine the rhythmic motion control signal.

12. The apparatus of claim 10, wherein the at least one processor is configured to:
acquire the model parameters and the operation environment parameter of the multi-legged robot;
based on the model parameters of the multi-legged robot, generate, by a central pattern generator, a periodic time signal; and
based on the periodic time signal, determine the rhythmic motion control signal.

13. A non-transitory computer readable storage medium stored with computer instructions, wherein, the computer instructions are configured to execute a method for controlling a multi-legged robot by a computer, the method comprises:
acquiring current state parameters of the multi-legged robot;
when types and/or quantities of the current state parameters meet a first preset condition, acquiring a first motion control policy by inputting the current state parameters into a first model generated by training; and
controlling the multi-legged robot based on the first motion control policy.

14. The storage medium of claim 13, after acquiring the current state parameters of the multi-legged robot, further comprising:
when the types and/or the quantities of the current state parameters do not meet the first preset condition, acquiring a second motion control policy by inputting the current state parameters into a second model generated by training; and
controlling the multi-legged robot based on the second motion control policy.

15. The storage medium of claim 14, before inputting the current state parameters into the first model generated by training, further comprising:
acquiring model parameters, an operation environment parameter and a rhythmic motion control signal of the multi-legged robot;
determining a preliminary gait control policy of the multi-legged robot based on the model parameters, the operation environment parameter and the rhythmic motion control signal of the multi-legged robot;
based on the preliminary gait control policy of the multi-legged robot, controlling the multi-legged robot model to move in an environment randomly generated to acquire a first state parameter set and a motion parameter set of the multi-legged robot;
acquiring an initial first motion control policy by inputting the first state parameter set, the motion parameter set and the preliminary gait control policy into an initial first model;
based on the initial first motion control policy, controlling the multi-legged robot model to move in the environment randomly generated to acquire state parameters and motion parameters of the multi-legged robot under the initial first motion control policy; and
based on the state parameters and motion parameters under the initial first motion control policy, adjusting the initial first model, and continuing to determine an adjusted first motion control strategy based on an adjusted first model and to determine motion parameters under the adjusted first motion control strategy based on the adjusted first motion control strategy, until the motion parameters of the multi-legged robot under the adjusted first motion control policy meets a second preset condition.

16. The storage medium of claim 15, after based on the state parameters and the motion parameters under the initial first motion control policy, adjusting the initial first model, until the motion parameters of the multi-legged robot under the adjusted first motion control policy determined based on the adjusted first model meets the second preset condition, further comprising:
extracting a second state parameter set from the first state parameter set, wherein, a quantity of state parameters comprised in the second state parameter set is less than a quantity of state parameters comprised in the first state parameter set;
acquiring an initial second motion control policy by inputting the first state parameter set, the second state parameter set and the first motion control policy finally determined based on the second preset condition into an initial second model; and
based on a difference between the initial second motion control policy and the first motion control policy finally determined based on the second preset condition, adjusting the initial second model, and continuing to determine an adjusted second motion control strategy based on an adjusted second model, until a difference between the adjusted second motion control policy and the first motion control policy finally determined based on the second preset condition meets a third preset condition.

17. The storage medium of claim 15, wherein acquiring the model parameters, the operation environment parameter and the rhythmic motion control signal of the multi-legged robot comprises:
acquiring the model parameters and the operation environment parameter of the multi-legged robot;
based on the model parameters of the multi-legged robot, generating, by a central pattern generator, a periodic time signal; and
based on the periodic time signal, determining the rhythmic motion control signal.

18. The storage medium of claim 16, wherein acquiring the model parameters, the operation environment parameter and the rhythmic motion control signal of the multi-legged robot comprises:
acquiring the model parameters and the operation environment parameter of the multi-legged robot;
based on the model parameters of the multi-legged robot, generating, by a central pattern generator, a periodic time signal; and
based on the periodic time signal, determining the rhythmic motion control signal.
